(19) United States
(12) Patent Application Publication
(10) Pub. No.: US 2010/0020036 A1
(43) Pub. Date: Jan. 28, 2010

(54) PORTABLE ELECTRONIC DEVICE AND METHOD OF CONTROLLING SAME

(76) Inventors: Edward Hui, Waterloo (CA); Zhongming Ma, Waterloo (CA); Perry Faubert, Surrey (CA); Arnett Weber, Waterloo (CA)

Correspondence Address: NOVAK DRUCE + QUIGG LLP (RIM), 1000 LOUISIANA STREET, FIFTY-THIRD FLOOR, HOUSTON, TX, 77002, US

(21) Appl. No.: 12/507,399

(22) Filed: Jul. 22, 2009

Related U.S. Application Data
(60) Provisional application No. 61/083,087, filed on Jul. 23, 2008.

(51) Int. Cl. G06F 3/041; G06F 3/01

(52) U.S. Cl. 345/173; 715/702

(57) ABSTRACT

A method includes displaying an image of a key on a touch-sensitive display and detecting a touch on the touch-sensitive display at a first location. When the first location is located in a predetermined area related the key, tactile feedback is provided that simulates a characteristic of a physical key. The touch-sensitive display may be part of a portable electronic device.

### CROSS-REFERENCE TO RELATED APPLICATIONS & PRIORITY CLAIM

This application claims priority benefit of U.S. Provisional Application No. 61/083,087 filed Jul. 23, 2008 and U.S. patent application Ser. No. 12/394,951 filed Feb. 27, 2009, which are expressly incorporated by reference herein.

### FIELD

The present disclosure relates to portable electronic devices, including but not limited to portable electronic devices having touch screen displays and their control.

### BACKGROUND

Electronic devices, including portable electronic devices, have gained widespread use and may provide a variety of functions including, for example, telephonic, electronic messaging and other personal information manager (PIM) application functions. Portable electronic devices include, for example, several types of mobile stations such as simple cellular telephones, smart telephones, wireless personal digital assistants (PDAs), and laptop computers with wireless 802.11 or Bluetooth capabilities. These devices run on a wide variety of networks from data-only networks such as Mobitex® and DataTAC® networks to complex voice and data networks such as GSM/GPRS, CDMA, EDGE, UMTS and CDMA2000 networks.

Portable electronic devices such as PDAs or smart telephones are generally intended for handheld use and ease of portability. Smaller devices are generally desirable for portability. A touch-sensitive display, also known as a touchscreen display, is particularly useful on handheld devices, which are small and have limited space for user input and output. The information displayed on the touch-sensitive displays may be modified depending on the functions and operations being performed. With continued demand for decreased size of portable electronic devices, touch-sensitive displays continue to decrease in size.

Improvements in touch-sensitive devices are therefore desirable.

### BRIEF DESCRIPTION OF THE DRAWINGS

FIG. 1 is a block diagram of a portable electronic device in a communication network in accordance with the disclosure.

FIG. 2 illustrates a side view of the touch-sensitive display in accordance with the disclosure.

FIG. 3 illustrates a side view of the touch-sensitive display shown when the actuators are actuated in accordance with the disclosure.

FIG. 4 illustrates locations of actuators and pressure sensors located with respect to a touch-sensitive display in accordance with the disclosure.

FIG. 5 illustrates four actuators and four pressure sensors located with respect to a touch-sensitive display in accordance with the disclosure.

FIG. 6 illustrates a plurality of actuators and force sensors disposed for each key of a displayed keyboard in accordance with the disclosure.

FIG. 7 illustrates a keyboard displayed on a touch-sensitive display of a portable electronic device in accordance with the disclosure.

FIG. 8 illustrates a pattern related to tactile feedback in relation to keys of a keyboard displayed on the touch-sensitive display in accordance with the disclosure.

FIG. 9 illustrates two consecutive touch locations on a keyboard displayed on the touch-sensitive display in accordance with the disclosure.

FIG. 10 illustrates a pattern of tactile feedback locations on keys of a keyboard displayed on the touch-sensitive display in accordance with the disclosure.

FIG. 11 illustrates a flowchart of a method of providing tactile feedback for a touch-sensitive display in accordance with the disclosure.

### DETAILED DESCRIPTION

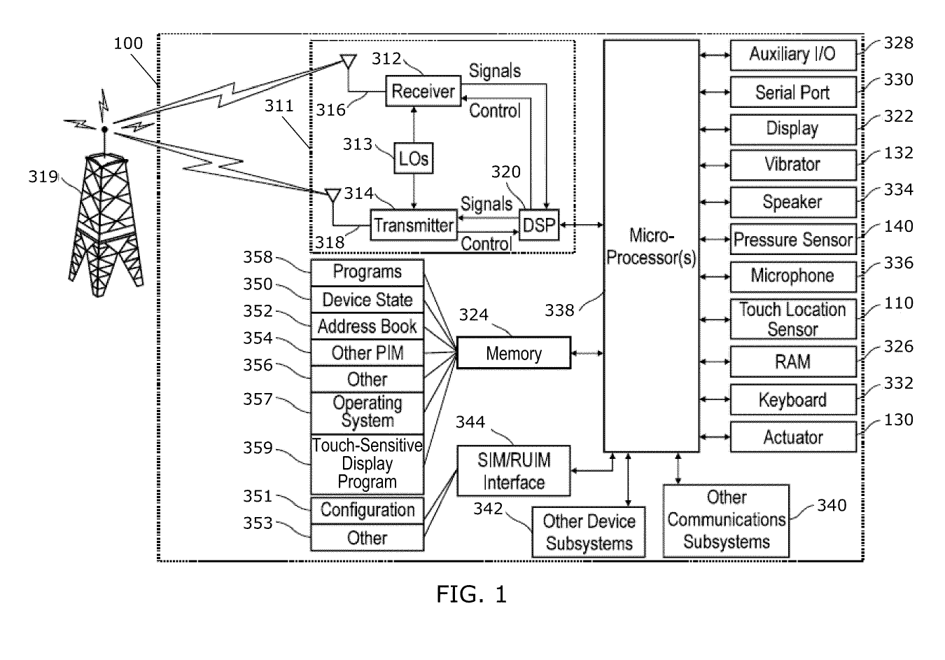

A block diagram of a portable electronic device 300 in a communication network is shown in FIG. 1. The electronic device 100 includes a microprocessor 338 that controls the operation of the electronic device 100, such as facilitating communications, providing a graphical user interface, executing programs, and so forth. A communication subsystem 311 performs communication transmission and reception with the wireless network 319. The microprocessor 338 further may be connected with an auxiliary input/output (I/O) subsystem 328 that may be connected to the device 100. Additionally, in at least one embodiment, the microprocessor 338 may be connected to a serial port (for example, a Universal Serial Bus port) 330 that facilitates communication with other devices or systems via the serial port 330. A display 322 is operably connected to microprocessor 338 to facilitate display of information to an operator of the device 100. When the electronic device 100 is equipped with a keyboard 332, which may be physical or virtual (i.e., displayed), the keyboard 332 is operably connected to the microprocessor 338. The electronic device 100 may include a speaker 334 and a microphone 336, which may advantageously be operably connected to the microprocessor. Additionally, a vibrator 132, which may be a vibrator motor, may be operably connected to the microprocessor 338 to generate vibrations in the electronic device 100. Other similar components may be provided on or within the device and are optionally operably connected to the microprocessor 338. Other communication subsystems 340 and other communication device subsystems 342 are generally indicated as functionally connected with the microprocessor 338. An example of a communication subsystem 340 is a short-range communication system such as a BLUETOOTH® communication module or a WI-FI® communication module (a communication module in compliance with IEEE 802.11b) and associated circuits and components. Additionally, the microprocessor 338 performs operating system functions and executes programs or software applications on the electronic device 100. In some embodiments, not all of the above components are included in the electronic device 100. The auxiliary I/O subsystem 328 may take the form of one or more different navigation tools (multi-directional or single-directional), external display devices such as keyboards, and other subsystems capable of providing input or receiving output from the electronic device 100.

The electronic device 100 is equipped with components to enable operation of various programs, as shown in FIG. 1. As shown in the embodiment of FIG. 1, the memory 324 provides storage for the operating system 357, device programs 358, data, and so forth. The operating system 357 is generally configured to manage other programs 358 that are also stored in memory 324 and executable on the processor 338. The operating system 357 handles requests for services made by programs 358 through predefined program 358 interfaces. More specifically, the operating system 357 typically determines the order in which multiple programs 358 are executed on the processor 338 and the execution time allotted for each program 358, manages the sharing of memory 324 among multiple programs 358, handles input and output to and from other device subsystems 342, and so forth. In addition, operators may interact directly with the operating system 357 through a user interface, typically including the keyboard 332 and display screen 322. The operating system 357, programs 358, data, and other information may be stored in memory 324, RAM 326, read-only memory (ROM), or another suitable storage element (not shown). An address book 352, personal information manager (PIM) 354, and other information 356 may also be stored.

The electronic device 100 may be enabled for two-way communication within voice, data, or voice and data communication systems. A Subscriber Identity Module (SIM) or Removable User Identity Module (RUIM) may be utilized to authorize communication with the communication network 319. A SIM/RUIM interface 344 within the electronic device 100 interfaces a SIM/RUIM card to the microprocessor 338 and facilitates removal or insertion of a SIM/RUIM card (not shown). The SIM/RUIM card features memory and holds key configurations 351, and other information 353 such as identification and subscriber related information. The electronic device 100 is equipped with an antenna 318 for transmitting signals to the communication network 319 and another antenna 316 for receiving communication from the communication network 319. Alternatively, a single antenna (not shown) may be utilized to transmit and receive signals. A communication subsystem 311 includes a transmitter 314 and receiver 312, one or more antennae 316, 318, local oscillators (LOs) 313, and a processing module 320 such as a digital signal processor (DSP) 320.

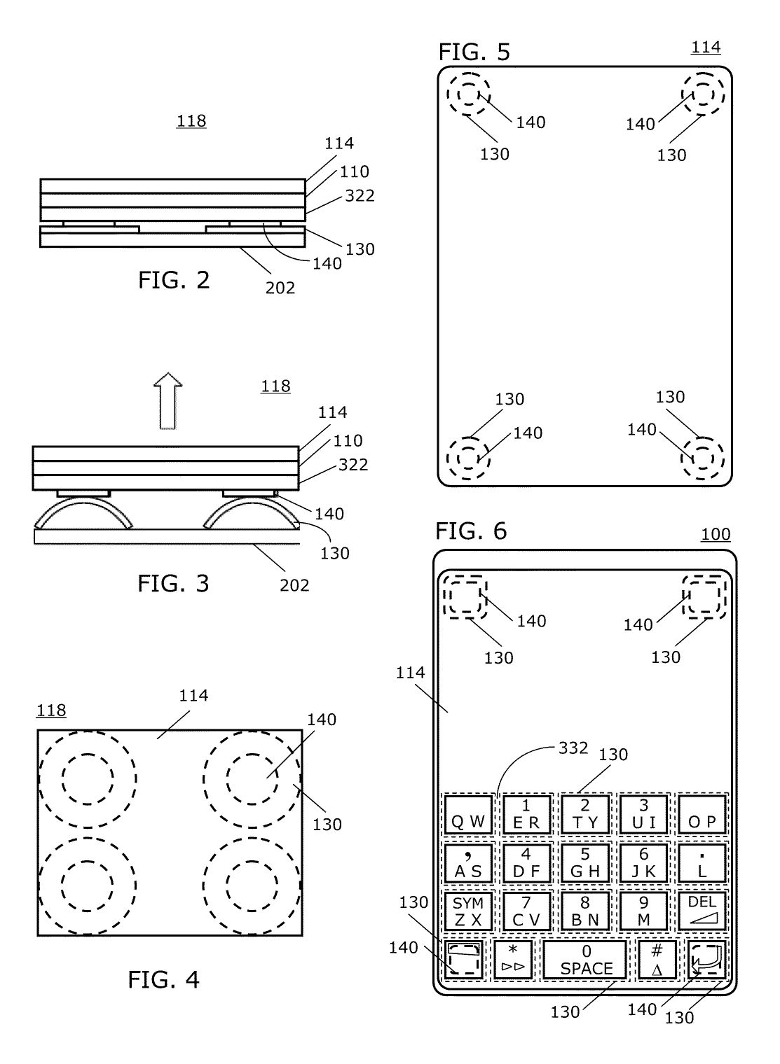

The electronic device 100 includes a touch-sensitive display 118 that includes one or more touch location sensors 110, an overlay 114, and a display 322, such as a liquid crystal display (LCD) or light emitting diode (LED) display, such as shown in FIG. 2 and FIG. 3. The touch location sensor(s) 110 may be a capacitive, resistive, infrared, surface acoustic wave (SAW), or other type of touch-sensitive sensor and may be integrated into the overlay 114. The overlay 114, or cover, may be comprised of laminated glass, plastic, or other suitable material(s) and is advantageously translucent or transparent. A touch, or touch contact, may be detected by the touch-sensitive display 118 and processed by the processor 338, for example, to determine a location of the touch. Touch location data may include the center of the area of contact or the entire area of contact for further processing. A touch may be detected from a contact member, such as a body part of a user, for example a finger or thumb, or other objects, for example a stylus, pen, or other pointer, depending on the nature of the touch location sensor.

The portable electronic device 100 processes contact location information received from the location sensor(s) 110 and determines one location of contact or alternatively two or more simultaneous locations of touch contact on the overlay 114. Two simultaneous locations of contact may occur, for example, when two fingers or thumbs are used to input data into the portable electronic device 100.

When the electronic device 100 includes one or more pressure sensors 140, the pressure sensor(s) 140 may provide data to the portable electronic device 100 to determine which of two detected simultaneous touches has greater contact pressure. This determination may be utilized to select which touch dictates the selection of data, functions, or commands associated with the touch. Time of touch may also be utilized as a factor in determining which touch controls selection.

One or more actuators or switches 130 and one or more pressure sensors 140 are also shown disposed in conjunction with the touch-sensitive display 118. Although the touch location sensor 110 is shown located above the display 322, the touch location sensor 110 may be located below the display 322. The actuators 130 may be affixed to a back, support, or base 202, which may include a printed circuit board (PCB). Alternatively, the actuator 130 may be affixed to an intermediary board or mounting structure between the actuator 130 and the base 202.

The pressure sensors 140 may be mounted beneath the display 322 and may optionally be affixed to the actuators 130. The pressure sensors 140 may optionally be mounted beneath the overlay 114. The pressure sensors 140 may optionally be placed in a parallel configuration with the actuators 130. For example, the pressure sensors 140 may be placed adjacent to the actuators 130 rather than above them. Other locations that facilitate measurement or detection of the force applied to the surface may be utilized.

The pressure sensors 140 facilitate the generation of contact pressure data that is processed by the microprocessor 338. The pressure sensors 140 may be strain gauges, piezoresistive devices, microelectromechanical systems (MEMS) devices, variable capacitance devices, pressure sensitive resistors, inductive based pressure sensors, Hall Effect pressure sensors, and so forth. The pressure sensors 140 detect and measure pressure or changes in pressure applied to the touch-sensitive display 118 through contact with the overlay 114.

Force sensors may optionally be utilized instead of pressure sensors. Examples of force sensors include, but are not limited to, force sensitive resistors, strain gauges, and piezoelectric devices. An actuator 130 may be comprised of a plurality of piezoelectric devices. The actuators 130 may be piezoelectric devices that expand and contract depending on applied voltage/current, applied force, or both. Examples of piezoelectric devices are shown in an expanded and in a contracted state, respectively, in FIGS. 2 and 3. The actuators 130 may advantageously be utilized to provide tactile feedback, as may be felt through contact with the overlay 114 of the touch-sensitive display, as described below.

When the actuators 130 are piezoelectric actuators such as piezoelectric (piezo) disks, each disk contracts or bends due to build up of charge/voltage. Force applied on each piezo disk through the overlay 114 also bends the piezo disk. Absent an external force applied to the overlay 114, and absent a charge on the piezo disk, the piezo disk is slightly bent due to a mechanical preload. A force applied to the touch-sensitive display 118, prior to actuation of the piezo disk, causes increased bending of the piezo disk, and the piezo disk applies a spring force against the touch-sensitive display 118. The piezo disks may be located between the base 202 and the display 322, such that charging of the piezo disks applies a force in a direction toward the overlay 114, away from the base 202. When the piezo disk is charged, it shrinks, causing the piezo disk to apply a further force on the touch-sensitive display 118, opposing the external applied force. The charge on the piezo disks may be adjusted to control the force applied by the piezo disks and the resulting movement of and/or force on the overlay 114. The charge is adjusted by varying the applied voltage or current. Increased charge on the piezo disk contracts the piezo disk, resulting in force on the overlay 114 that opposes the externally applied force. The charge on the piezo disk may also be removed by a controlled discharge of current, causing the piezo disk 316 to expand, releasing the force caused by the electric charge and decreasing force on the touch screen display 118 applied by the piezo disks.

The touch-sensitive display 118 may provide tactile feedback in a similar fashion to a physical key, thereby simulating depression and release of a physical key. Pressure data due to touch contact provided by the pressure sensor(s) 140 may at least partially facilitate such feedback. For example, if one Newton of force is utilized as the force necessary to select a key, a threshold may be set for selection at one Newton.

The actuators 130 and pressure sensors 140 may be located in a variety of different layouts or configurations. For example, four actuators 130 and four pressure sensors 140 are shown disposed near the corners of the overlay 114 in FIG. 4 and FIG. 5. The actuators 130 and pressure sensors 140 are shown located concentrically with respect to each other. The actuators 130 and pressure sensors 140 are not necessarily shown to scale, and some features may be exaggerated or minimized to focus on specific details of various components. One or more actuators 130 and one or more pressure sensors 140 may be utilized. Each actuator 130 need not be paired with a pressure sensor 140. For example, two pressure sensors 140 may be disposed near opposite corners, while two actuators 130 are disposed in the other two corners. Numerous actuators 130 may be disposed in locations where keys or buttons are often displayed. For example, an actuator 130 may be disposed with respect to each displayed key of a virtual keyboard 332, such as shown in FIG. 6. Two or more keys may share an actuator 130. In the example shown, two pressure sensors 140 are shown at opposite ends of the lowest row of virtual keys, and two other pressure sensors 140 are located at the opposite part of the overlay 114 where an application interface or other information is displayed.

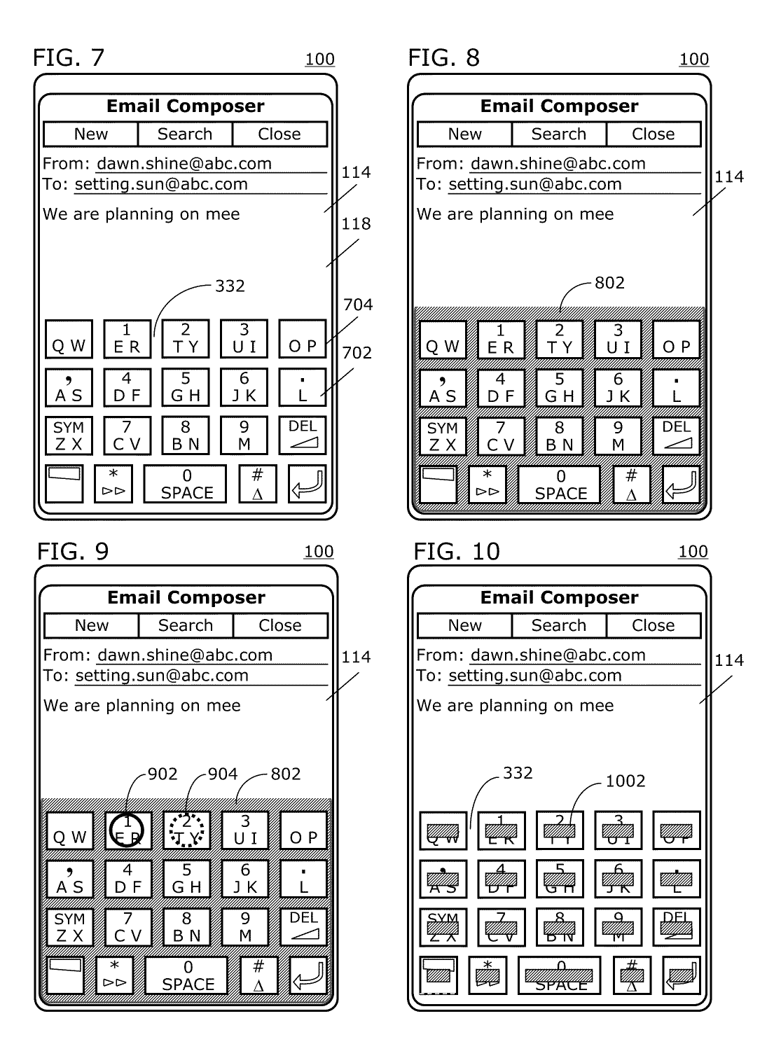

An example electronic device 100 is shown in FIG. 7. The embodiments depicted in the figures show examples only, and persons skilled in the art understand the additional elements and modifications necessary to make the electronic device 100 operate in particular network environments. Although the electronic device 100 comprises a handheld communication device, the electronic device 100 may comprise a handheld wireless communication device, a personal digital assistant (PDA), laptop computer, desktop computer, a server, other communication device, or other portable computing device.

The term “keys” as utilized herein, includes virtual or displayed keys or buttons that are images displayed on a touch-sensitive display. Keys may be associated with characters, such as letters, numbers, spaces, and punctuation marks, and/or functions, such as shift, control, alpha, numeric, symbol, alternate, delete, return, enter, power, and so forth, and/or symbols representing actions or operations, for example, play, stop, and pause for a media player, previous and next for a web browser, and so forth. Thus, the term “keys” is not limited to keys from a keyboard, although the examples provided herein are provided in the context of keys of a keyboard.

The portable electronic device 100 may include programs that utilize text or data entry programs or subroutines, such as a note pad, task book, address book, email, and text message program, to name a few. An email composer segment of an email program is shown in FIG. 7. The email composer facilitates creation of a new email message. The email composer shown includes virtual keys that provide for creation of a new email message, searching previous email messages, and the option to close the email composer. Other options may be provided but are not shown for the sake of simplicity.

To aid in text entry, the displayed keyboard 332 includes a plurality of images of keys 702 that constitute virtual representations of physical keys on a display 322 as shown in FIG. 7. One or more physical keys may also be included (not shown) and may be utilized in conjunction with virtual keys. Each key image 702 includes an outer border or frame 704. Each key is associated with at least one action, such as the input of a character, a command, or a function. Characters include, for example, alphabetic letters, symbols, numbers, punctuation, insignias, icons, pictures, and blank spaces. The illustrated keyboard 332 has alphabetic and numeric characters arranged in a reduced QWERTY keyboard layout, in addition to other functions, such as capitalization and symbol keys that bring up alternate keys for display. Delete and enter keys are also shown. In other embodiments, a full QWERTY, QWERTZ, AZERTY, Dvorak, or other layout may be provided.

When typing on a physical keyboard, a user has the benefit of both seeing and touching the keys. Users may learn to type without looking at the keyboard, for example, by sensing the edges of the physical keys. When a virtual keyboard is displayed, the key images 702 themselves do not provide tactile sensation or feedback.

The present disclosure describes a solution whereby tactile sensation is provided on a touch-sensitive display 118 to aid in information entry such as text or data entry. The actuators 130 provide tactile feedback when a touch is detected in predetermined areas of the touch-sensitive display 118. The feedback may include vibration, pulse, or other sensations caused by one or more actuators 130, which feedback may be felt on the outer surface of the touch-sensitive display 118. The vibration may, for example, be generated in the ultrasonic frequency range, such that the user feels a surface characteristic or texture, such as edges, bumps, ridges, ribs, grooves, or friction. When ultrasonic frequency vibrations are utilized, the user may feel the surface characteristic or texture rather than feeling individual vibrations or pulses. This provision of tactile feedback may be described as inducing modulation of the overlay 114 of the touch-sensitive display 118 when a touch is detected. Use of ultrasonic frequency vibration is known. While the term vibration is used herein, other types of modulation that produce similar tactilely distinguishable surfaces are considered within the scope of this disclosure.

The tactile feedback as described herein may be applied during a program that displays a virtual keyboard 332, such as shown in the figures. Tactile feedback may be applied in such a way as to simulate the outer edges of physical keys by providing tactile feedback when a touch is detected at or near a border of one or more of the key images 702 of the virtual keyboard 332. When tactile feedback is provided for each key of the virtual keyboard 332, a pattern 802 is formed that surrounds the outer edges of the keys and may also include the areas between the keys, such as shown in FIG. 8. When a touch is detected on the touch-sensitive display 118, a location of the touch is determined, e.g., by the touch location sensor 110 in conjunction with the microprocessor 338. When the touch is determined to be located in the shaded area of the pattern 802, tactile feedback is provided, for example, through microprocessor 338 control of the actuators 130. Although the pattern 802 is not visible, the pattern 802 may overlap a part of the one or more key images 702, such that tactile feedback may be felt internally to the border 704 of the key being touched. Optionally, the pattern 802 may be set away from the visible borders 704 of the keys, thus tactile feedback may be felt somewhat outside the borders 704.

An email message during composition is shown in FIG. 9. Presuming the word “meeting” is being entered, and the user has finished entering the second “e” in “meeting,” the user's finger moves from the “1ER” key to the “2TY” key to enter the “t.” If the portable electronic device 100 detects a touch location in the area of the pattern 802, tactile feedback is provided. Such detection may occur, for example, when a finger that was positioned above the “1ER” key image 702 moves to the “2TY” key image 702 while contacting the touch-sensitive display 118. For example, the user may utilize a sliding contact, also known as a swipe, from a first touch contact area 902 in FIG. 9 through an area of the pattern 802, and to a second touch contact area 904. Alternatively, the touch may be comprised of multiple contacts from the first contact area 902 to the second contact area 904, one or more of which are located in the area of the pattern 802, and thus cause tactile feedback to be generated.

The tactile feedback may be simple, such as a vibration or pulse of force against the finger or other contacting member. Alternatively, the tactile feedback provided by the portable electronic device 100 may cause the user to feel a bump, edge, ridge, or groove between the borders of the two keys, e.g., where the pattern 802 is shown. Thus, the tactile feedback may simulate physical edges, ridges, or grooves in the area where the pattern 802 is formed. For example, the user may feel a single bump or ridge between the key images 702, or two distinct bumps or ridges, one for each key border. In another example, the user may feel a single groove between the key images 702, or two distinct grooves, one for each key border. By modulating the actuator 130 output, different textures, characteristics, or sensations may be provided as tactile feedback. The tactile feedback may be based, for example, on a force-displacement curve associated with a physical key. Feedback may be provided locally, i.e., where a touch is detected, or may be provided across most or all of the overlay 114. When multiple simultaneous touches are detected, different feedback may be provided locally at each detected touch location.

Alternatively, tactile feedback may be provided when the contacting member is on or near the center or middle of the key image 702, such as the locators found on the “f” and “k” keys on a QWERTY keyboard utilized to assist a user to place index fingers. A pattern 1002 of areas where tactile feedback is provided is located away from the edges, for example, near the centers of each displayed key of the virtual keyboard 332, as shown in FIG. 10. Tactile feedback may be provided to simulate a ridge or bump, but may alternatively be provided in the form of additional friction along the surface of the overlay 114. Although the pattern 1002 is shown on each of the keys, the pattern 1002 may be provided on fewer than all of the keys of the keyboard 332. The pattern 1002 may also be extended to the “New, “Search,” and “Close” buttons (not shown). Combinations of the two patterns 802, 1002 of feedback locations may also be utilized. For example, the inter-key pattern 802 may be utilized in conjunction with one or more locators that are a subset of the internal pattern 1002 associated with one or more keys. For example, the individual locators of the pattern 1002 may be the “5GH” key or “8BN” key; the “2TY” and “0-SPACE” keys; or the “2TY, “”5GH,” “8BN,” and “0SPACE” keys, to name a few options. This pattern 1002 may be comprised of smaller areas of feedback than shown in FIG. 10, and the areas may be located near or along one edge of each displayed key, such as the bottom or top of each displayed key from the perspective of the user. The pattern 1002 may be comprised of vertical areas, instead of or in addition to the horizontal areas shown, as viewed by the user. The individual components of the pattern 1002 may have different shapes, such as one or more bumps, squares, circles, triangles, and so forth.

This tactile feedback provision facilitates data entry by a user to enter without looking at the key images 702. For instance, a sweeping, swiping, or sliding contact, known as a swipe or gesture, of a finger of the user starts at the “QW” key image 702 and ends at the “CAPS-OP” key image 702, tactile feedback is provided for each of the four key changes at the borders 704 associated with five keys. Similarly, the user may find the “0-SPACE” key from the “QW” key by detecting feedback twice in the horizontal direction and three times in the vertical direction, where horizontal and vertical refer only to the user's viewpoint of the overlay 114.

The pressure sensor(s) 140 and or touch location sensor(s) 110 may be utilized to determine touch location data indicative of a sweeping, swiping, or sliding contact. Such information may be useful to select from among two or more detected simultaneous touch locations. Such a determination may be utilized, for example, to select the touch location for providing tactile feedback. For example, the pressure of touch contact may be used to determine which simultaneous contact location to track when a sliding, swiping, or sweeping contact is detected.

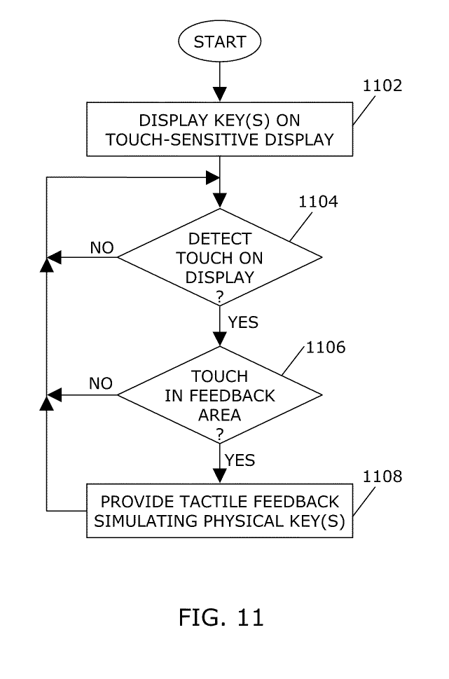

A flowchart illustrating a method of providing tactile feedback for a touch-sensitive display is shown in FIG. 11. The portable electronic device 100 performs the processes of the flowchart and may utilize its processor 338 to run software to perform some or all of the steps, as known in the art. The software may be, for example, part of a touch-sensitive display program 359 shown stored in memory 324 in FIG. 1. In addition to performing the flowchart of FIG. 11, the touch-sensitive display program 359 may also display information on the display 322, provide a graphical user interface, determine the location of touches with respect to application information, interact with actuators 130 and pressure sensors 140, and so forth.

One or more keys, such as the keys of a keyboard, are displayed 1102 on the touch-sensitive display 118. When a touch is detected 1104 on the touch-sensitive display 118, the processor 338 or other device determines whether the location of the touch is within a feedback area such as the external pattern 802 of FIG. 8 or the internal pattern 1002 of FIG. 10. When the location is within one of the predetermined areas of one or more of the patterns 802, 1002 at 1106, tactile feedback is provided 1108 that simulates a characteristic of a physical key. The characteristic of the physical key may be, as described above, a surface characteristic or texture, such as edges, bumps, ridges, ribs, grooves, or friction. Thus, an edge, texture, or a physical locator of a physical key, for example, may be simulated as described above. When the location is not within one of the predetermined areas of the patterns 802, 1002, the process continues with step 1104.

Although the figures illustrate an email composer program, the disclosure may be applied to other text or data entry applications and other applications in which a selectable item is displayed on the touch-sensitive display 118.

Although the above embodiments are described in relation to displayed keys, the tactile feedback, as provided by one or more actuator(s) 130, may be provided in conjunction with other images or items on the display 118. If an image of a mountain is displayed on the display screen 322, the tactile feedback may simulate the texture displayed in the image of the mountain on the display using the touch location data as described above. In order to simulate the ridges and valleys of the displayed mountain, the tactile feedback on the overlay 114 may be provided based upon location of the contact in relation to the displayed image of the mountain. Tactile image simulation may be generated based upon other displayed images, such as the texture of a flower, a beach, or a cliff. Such tactile feedback may be provided with other programs such as internet browsers, email programs, messaging programs and other programs in which tactile perception may be useful to the user. Additional embodiments based upon this disclosure may be readily discernable by one of ordinary skill in the art.

A portable electronic device comprises a touch-sensitive display arranged and constructed to detect a touch and a microprocessor and memory arranged and constructed to display an image of a key on the touch-sensitive display and, when the touch is located in a predetermined area associated with the key, providing tactile feedback simulating a characteristic of a physical key. The predetermined area may be near or outside a border of the image of the key. The predetermined area may be internal to a border of the image of the key. The characteristic may be an edge of a key. The characteristic may be a locator disposed on a key. A plurality of keys may be displayed on the touch-sensitive display and the predetermined area may be comprised of a plurality of areas associated with each of the plurality of keys. The at least one actuator may be a piezoelectric actuator that provides the tactile feedback. At least one actuator that vibrates in an ultrasonic frequency range may provide tactile feedback. The tactile feedback may simulate at least one of an edge, a bump, a ridge, and a groove. At least one pressure sensor may provide pressure data associated with a detected touch.

A method comprises displaying an image of a key on a touch-sensitive display, detecting a touch on the touch-sensitive display at a first location, and, when the first location is located in a predetermined area related the key, providing tactile feedback simulating a characteristic of a physical key.

The tactile feedback may simulate an edge of a physical key. The tactile feedback may simulate a locator disposed on a physical key. An actuator may be vibrated in an ultrasonic frequency range to provide tactile feedback. The tactile feedback may simulate at least one of an edge, a bump, a ridge, and a groove. Pressure data may be utilized to select between two simultaneous touch locations to provide tactile feedback. The predetermined area may be near or at a border of the image of the key. The predetermined area may be internal to a border of the image of the key. A plurality of keys may be displayed on the touch-sensitive display and the predetermined area may be comprised of a plurality of areas associated with each of the plurality of keys. A computer-readable medium may have computer-readable code embodied therein, the computer-readable code executable by a processor of the portable electronic device to perform the method.

Tactile feedback may be provided at and/or near the borders of images of keys on a touch-sensitive display, which may include the area between the images of keys. Alternatively, tactile feedback may be provided internally to the image of a key, i.e., at or near the center area of the keys. Such tactile feedback may simulate the edges of physical keys, ridges or grooves between keys, or location ridges on keys, rendering retention of contacting members on displayed keys more successful. As a result, users may type more quickly and/or accurately on a touch-sensitive display. Tactile feedback may simulate physical structures without providing physical structures. A virtual keyboard may be rendered in different orientations, with different numbers of keys, in different sizes, and in various layouts such as portrait or landscape, without being limited by physical structures, such as ridges or grooves, in fixed locations on the display.

The present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes that come within the meaning and range of equivalency of the claims are to be embraced within their scope.

What is claimed is:

1. A portable electronic device comprising:
a touch-sensitive display arranged and constructed to detect a touch;
a microprocessor and memory arranged and constructed to:
display an image of a key on the touch-sensitive display;
when the touch is located in a predetermined area associated with the key, providing tactile feedback simulating a characteristic of a physical key.

2. The portable electronic device of claim 1, wherein the predetermined area is near or outside a border of the image of the key.

3. The portable electronic device of claim 1, wherein the predetermined area is internal to a border of the image of the key.

4. The portable electronic device of claim 1, wherein the characteristic is an edge of a key.

5. The portable electronic device of claim 1, wherein the characteristic is a locator disposed on a key.

6. The portable electronic device of claim 1, wherein a plurality of keys are displayed on the touch-sensitive display and the predetermined area is comprised of a plurality of areas associated with each of the plurality of keys.

7. The portable electronic device of claim 6, wherein the at least one actuator is a piezoelectric actuator that provides the tactile feedback.

8. The portable electronic device of claim 1, further comprising at least one actuator that vibrates in an ultrasonic frequency range to provide tactile feedback.

9. The portable electronic device of claim 7, wherein the tactile feedback simulates at least one of an edge, a bump, a ridge, and a groove.

10. The portable electronic device of claim 1, further comprising at least one pressure sensor that provides pressure data associated with a detected touch.

11. A method comprising:
displaying an image of a key on a touch-sensitive display;
detecting a touch on the touch-sensitive display at a first location;
when the first location is located in a predetermined area related the key, providing tactile feedback simulating a characteristic of a physical key.

12. The method of claim 11, wherein the tactile feedback simulates an edge of a physical key.

13. The method of claim 11, wherein the tactile feedback simulates a locator disposed on a physical key.

14. The method of claim 11, further comprising vibrating an actuator in an ultrasonic frequency range to provide tactile feedback.

15. The method of claim 11, wherein the tactile feedback simulates at least one of an edge, a bump, a ridge, and a groove.

16. The method of claim 11, further comprising utilizing pressure data to select between two simultaneous touch locations to provide tactile feedback.

17. The method of claim 11, wherein the predetermined area is near or at a border of the image of the key.

18. The method of claim 11, wherein the predetermined area is internal to a border of the image of the key.

19. The method of claim 11, wherein a plurality of keys are displayed on the touch-sensitive display and the predetermined area is comprised of a plurality of areas associated with each of the plurality of keys.

20. A computer-readable medium having computer-readable code executable by at least one processor of the portable electronic device to perform the method of claim 11.
